(19) United States
(12) Patent Application Publication
(10) Pub. No.: US 2022/0274441 A1
(43) Pub. Date: Sep. 1, 2022

(54) ROLLER ASSEMBLY

(71) Applicant: SHENZHEN WIRELESS-TAG TECHNOLOGY CO., LIMITED, Shenzhen City (CN)

(72) Inventors: ZHOUGANG WEN, Shenzhen City (CN); YUNXIANG MU, Shenzhen City (CN); HUI LI, Shenzhen City (CN); HONGGANG WANG, Shenzhen City (CN)

(21) Appl. No.: 17/739,157

(22) Filed: May 8, 2022

Related U.S. Application Data
(63) Continuation of application No. PCT/CN2021/077555, filed on Feb. 24, 2021.

(30) Foreign Application Priority Data
Feb. 8, 2021 (CN) 202120350829.X

(51) Int. Cl. B60B 33/00

(52) U.S. Cl. CPC B60B 33/0044; B60B 33/0028; B60B 2380/22

(57) ABSTRACT

The present disclosure relates to the technical field of rollers, and provides a roller assembly, including: a fixing cover, a roller, a round magnet and a rotating shaft. The roller assembly further includes a bearing. The bearing is coaxially connected to an end of the rotating shaft; the roller is coaxially sleeved on an outer surface of the bearing; and the round magnet is coaxially connected to another end of the rotating shaft. By this way, the bearing structure is more precise, thereby enabling a better customer experience, a longer product life, and a simple structure for easy installation.

### CROSS REFERENCE TO RELATED APPLICATIONS

The present application is a bypass continuation of International (PCT) Patent Application No. PCT/CN2021/077555, filed on Feb. 24, 2021, which claims benefit of a Chinese Patent Application No. 202120350829.X, filed on Feb. 8, 2021, the disclosure of which is incorporated by reference herein.

### TECHNICAL FIELD

The present disclosure relates to the technical field of rollers, and more specifically, to a roller assembly.

### BACKGROUND

As the electrical industry rapidly advances, various devices with knobs are widely used in washing machines, microwave ovens and many other products, which causes an increase demand for roller assemblies in the knob devices.

However, as consumers have increasing requirements for product experience, and various types of products have different sizes, it is necessary for an easy-to-install and high-precision roller assembly to be used in various devices.

### SUMMARY

In view of the above problems, the present disclosure provides a roller assembly, aiming to allow the roller assembly to be more precise, and have a simple structure for easy installation.

In order to solve the above technical problems, a technical solution adopted by the present disclosure is to provide a roller assembly, including: a fixing cover, a roller, a round magnet and a rotating shaft. The roller assembly further includes a bearing. The bearing is coaxially connected to an end of the rotating shaft; the roller is coaxially sleeved on an outer surface of the bearing; and the round magnet is coaxially connected to another end of the rotating shaft.

Further, the fixing cover includes an upper cover and a base. The upper cover and the base are configured to fix the roller, the round magnet, the rotating shaft and the bearing therein.

Further, the upper cover is provided with:

a first groove, matched with the roller and configured to accommodate an upper portion of the roller;

a second groove, matched with the rotating shaft; and

a first notch, matched with the round magnet.

Further, the base is provided with:

a first opening, matched with the roller, the first groove and the first opening forming a semi-closed first accommodating cavity that is configured to accommodate the roller;

a third groove, matched with the rotating shaft, the second groove and the third groove forming a second accommodating cavity that is configured to accommodate the rotating shaft; and

a second notch, matched with the round magnet.

Further, a thickness of the base is smaller than an outer radius of the roller.

Further, the upper cover is further provided with two cylindrical protrusions facing towards the base, and the base is provided with two round openings matched with the protrusions, the cylindrical protrusions are fitted in the round openings to snap-fit the upper cover and the base.

Further, the roller assembly further includes a screw, and the fixing cover is provided with a screw hole.

Further, there are two screw holes, which are arranged at an end of the fixing cover close to the round magnet.

The present disclosure has the beneficial effects: different from the related art, the bearing structure of the roller assembly of the present disclosure is reasonable, which makes the entire roller assembly to have a higher precision, a better customer experience, and a longer product life. In addition, the entire roller assembly has a simple structure and is easy to install.

### BRIEF DESCRIPTION OF THE DRAWINGS

To describe the technical solutions in the embodiments of the present disclosure more clearly, the following briefly introduces the accompanying drawings required for describing the embodiments. Apparently, the accompanying drawings in the following description show only some embodiments of this application, and a person of ordinary skill in the art may still derive other accompanying drawings from these accompanying drawings without creative efforts.

FIG. 1 is a structural schematic view of a roller assembly of the present disclosure.

FIG. 2 is an exploded view of a roller assembly of the present disclosure according to a first embodiment.

FIG. 3 is an exploded view of a roller assembly of the present disclosure according to a second embodiment.

### LIST OF REFERENCE SIGNS

| Reference | | Reference | |
|---|---|---|---|
| sign | Name | sign | Name |
| 1 | Fixing cover | 2 | Roller |
| 3 | Round magnet | 4 | Rotating shaft |
| 5 | Bearing | 12 | Upper cover |
| 14 | Base | 16 | Screw hole |
| 122 | First groove | 124 | Second groove |
| 126 | First notch | 128 | Cylindrical protrusions |
| 142 | First opening | 144 | Third groove |
| 146 | Second notch | 148 | Round opening |

### DETAILED DESCRIPTION OF THE EMBODIMENTS

The technical solution in the embodiments of the present disclosure will be clearly and completely described below with reference to the drawings in the embodiments of the present disclosure. It will be appreciated that the specific embodiments described herein are only used to explain the present disclosure, but not to limit the present disclosure. In addition, for ease of description, the drawings only show a part of the structure related to the present disclosure instead of all of the structure. Based on the embodiments in present disclosure, all other embodiments obtained by a person of ordinary skill in the art without any creative work shall fall within the protection scope of the present disclosure.

It should be noted that all the directional indicators in the embodiments of the present disclosure, such as up, down, left, right, front, back . . . are only used to explain relative positional relationships, motion statuses, and etc. between components in a specific posture as shown in the accompanying drawings. The directional indicators will change accordingly as the specific posture changes.

In addition, the terms related to “first”, “second”, etc. in the present disclosure are only used for descriptive purposes, and cannot be interpreted as indicating or implying their relative importance or implicitly indicating the number of indicated technical features. Therefore, the features defined with “first” and “second” may explicitly or implicitly include at least one of the features. Moreover, the technical solutions between various embodiments can be combined with each other based on what can be achieved by a person of ordinary skill in the art. If the combination of technical solutions is contradictory or cannot be achieved, it should be considered that such a combination of technical solutions does not exist, nor is it within the protection scope of the present disclosure.

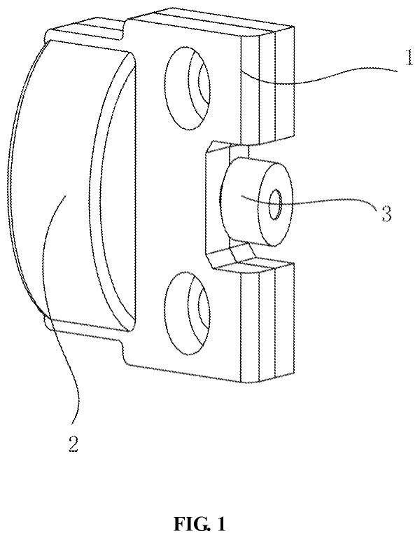

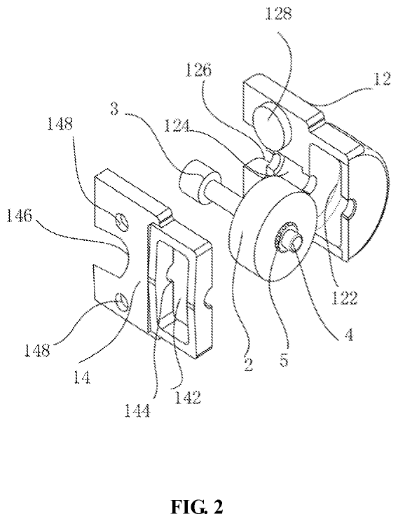

Referring to FIG. 1 and FIG. 2, a technical solution provided by the present disclosure is a roller assembly.

The roller assembly includes: a fixing cover 1, a roller 2, a round magnet 3, a rotating shaft 4, and a bearing 5.

The bearing 5 is coaxially connected to an end of the rotating shaft 4. The roller 2 is coaxially sleeved on an outer surface of the bearing 5. In order to allow that the roller 2 is tightly sleeved on the bearing 5, it is necessary to select the bearing 5 and the roller 2 that are adapted to each other according to an actual size in actual application. The round magnet 3 is axially connected to another end of the rotating shaft 4.

Further, the fixing cover 1 includes an upper cover 12 and a base 14. The upper cover 12 and the base 14 are configured to fix the roller 2, the round magnet 3, the rotating shaft 4 and the bearing 5 therein.

Further, the upper cover 12 is also provided with:

a first groove 122 that is matched with the roller 2 and capable of accommodating an upper portion of the roller 2;

a second groove 124 that is matched with the rotating shaft 4; and

a first notch 126 that is matched with the round magnet 3.

The base 14 is also provided with:

a first opening 142 that is matched with the roller 2, the first groove 122 and the first opening 142 forming a semi-closed first accommodating cavity that is capable of accommodating the roller;

a third groove 144 that is matched with the rotating shaft 4, the second groove 124 and the third groove 144 forming a second accommodating cavity that is capable of accommodating the rotating shaft; and

a second notch 146 that is matched with the round magnet 3.

It will be appreciated that the roller assembly has a simple structure and is easy to assemble. After assembling the roller 2 with the round magnet 3, the rotating shaft 4 and the bearing 5, the roller 2, the round magnet 3, the rotating shaft 4, and the bearing 5 are fixed in a hot melt manner, and then the upper cover 12 and the base 14 are glued together, thereby the assembly process is finished.

Further, a thickness of the base 14 is smaller than an outer radius of the roller 2, so that a lower portion of the roller 2 may be partially exposed outside the fixing cover. When the roller 2 slides under an action of an external force, the roller 2 drives the round magnet 3 to synchronously rotate.

The bearing 5 is configured to reduce a friction coefficient during a motion process of the roller 2 and ensure a rotation accuracy of the roller 2.

In some specific embodiments, the upper cover 12 is also provided with two cylindrical protrusions 128 facing the base. The base 14 is provided with two round openings 148 that are matched with the protrusions 128. The protrusions 128 may directly snap-fit in the round openings 148, so that the upper cover 12 and the base 14 can be easily closed.

It will be appreciated that the roller assembly has a simple structure and is easy to assemble. After assembling the roller 2 with the round magnet 3, the rotating shaft 4 and the bearing 5, they are placed in the fixing cover 1, and then the upper cover 12 and the base 14 are fastened, thereby the assembly process is finished.

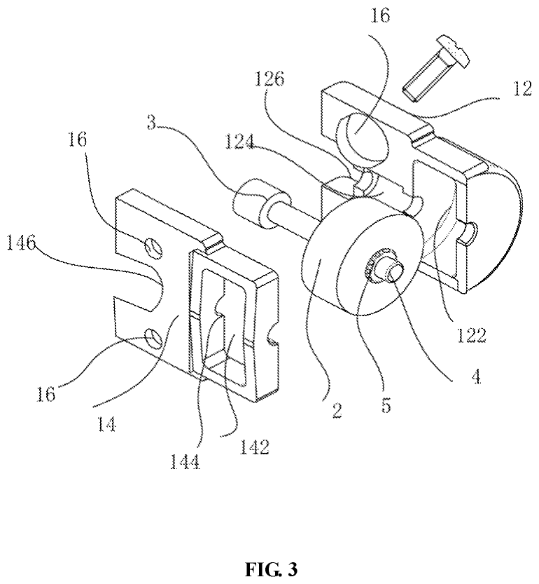

Referring to FIG. 3, in some specific embodiments, the roller assembly further includes a screw, and the fixing cover 1 is provided with a screw hole 16, the screw and the screw hole 16 are used to replace the foregoing protrusion 128 and the round opening 148 to achieve the same effect. As compared to the direct snap-fit manner, this manner is suitable to scenarios that require higher robustness.

Further, there are two screw holes 16 arranged at an end of the fixing cover 1 close to the round magnet 3, which are used to install two screws for fixing. In actual application, a quantity of the screw holes 16 and a quantity of the screws may be determined according to situations. As there are various types of screws, selections may be determined according to specific conditions. Herein, there is no limitation on the specific type and quantity of screws.

Further, the roller 2 of the roller assembly has a small diameter, which can achieve high-precision rolling sensing in the case of the same rotation distance. In addition, the size of the roller may be changed as needed to achieve a positioning precision required by the product.

It will be appreciated that the roller assembly has a small overall size, thus can be adapted to installation requirements of products of various sizes without relying on the overall structural design.

Different from the related art, the roller assembly according to the present disclosure includes a fixing cover, a roller, a round magnet and a rotating shaft. The roller assembly further includes a bearing. The bearing is coaxially connected to an end of the rotating shaft; the roller is coaxially sleeved on an outer surface of the bearing; and the round magnet is coaxially connected to another end of the rotating shaft. By this way, the bearing structure is more precise, thereby enabling a better customer experience, a longer product life, and a simple structure for easy installation.

In the embodiments provided in present disclosure, it will be appreciated that the disclosed structure may be implemented in other manners. For example, the foregoing structural implementations are merely illustrative, and there may be other divisions in actual implementation. For example, multiple units or components may be combined or integrated into another system, or some features may be omitted or not implemented.

The foregoing are only embodiments in accordance with the present disclosure and therefore not intended to limit the patentable scope of the present disclosure. Any equivalent structure or flow transformations that are made taking advantage of the specification and accompanying drawings of the disclosure and any direct or indirect disclosures thereof in other related technical fields are within the protection scope of the present disclosure.

What is claimed is:

1. A roller assembly, comprising: a fixing cover, a roller, a round magnet and a rotating shaft, wherein:
the roller assembly further comprises a bearing;
the bearing is coaxially connected to an end of the rotating shaft;
the roller is coaxially sleeved on an outer surface of the bearing; and
the round magnet is coaxially connected to another end of the rotating shaft.

2. The roller assembly according to claim 1, wherein, the fixing cover comprises an upper cover and a base, the upper cover and the base are configured to fix the roller, the round magnet, the rotating shaft, and the bearing therein.

3. The roller assembly according to claim 2, wherein, the upper cover is provided with:
a first groove, matched with the roller and configured to accommodate an upper portion of the roller;
a second groove, matched with the rotating shaft; and
a first notch, matched with the round magnet.

4. The roller assembly according to claim 3, wherein, the base is provided with:
a first opening, matched with the roller, the first groove and the first opening forming a semi-closed first accommodating cavity configured to accommodate the roller;
a third groove, matched with the rotating shaft, the second groove and the third groove forming a second accommodating cavity configured to accommodate the rotating shaft; and
a second notch, matched with the round magnet.

5. The roller assembly according to claim 2, wherein, a thickness of the base is smaller than an outer radius of the roller.

6. The roller assembly according to claim 5, wherein, the upper cover is further provided with two cylindrical protrusions facing the base, and the base is provided with two round openings matched with the protrusions, the cylindrical protrusions are fitted in the round openings to snap-fit the upper cover and the base.

7. The roller assembly according to claim 5, wherein, the roller assembly further comprises a screw, and the fixing cover is provided with a screw hole.

8. The roller assembly according to claim 7, wherein, the screw hole is one of two screw holes, and the two screw holes are arranged at an end of the fixing cover close to the round magnet.

9. The roller assembly according to claim 3, wherein, a thickness of the base is smaller than an outer radius of the roller.

10. The roller assembly according to claim 9, wherein, the upper cover is further provided with two cylindrical protrusions facing the base, and the base is provided with two round openings matched with the protrusions, the cylindrical protrusions are fitted in the round openings to snap-fit the upper cover and the base.

11. The roller assembly according to claim 9, wherein, the roller assembly further comprises a screw, and the fixing cover is provided with a screw hole.

12. The roller assembly according to claim 11, wherein, the screw hole is one of two screw holes, and the two screw holes are arranged at an end of the fixing cover close to the round magnet.

13. The roller assembly according to claim 4, wherein, a thickness of the base is smaller than an outer radius of the roller.

14. The roller assembly according to claim 13, wherein, the upper cover is further provided with two cylindrical protrusions facing the base, and the base is provided with two round openings matched with the protrusions, the cylindrical protrusions are fitted in the round openings to snap-fit the upper cover and the base.

15. The roller assembly according to claim 13, wherein, the roller assembly further comprises a screw, and the fixing cover is provided with a screw hole.

16. The roller assembly according to claim 15, wherein, the screw hole is one of two screw holes, and the two screw holes are arranged at an end of the fixing cover close to the round magnet.
